(19) United States
(12) Patent Application Publication
(10) Pub. No.: US 2026/0252969 A1
(43) Pub. Date: Aug. 27, 2026

(54) Control Unit for Fine-Tune an Intelligence Module Using Multiple Data Types and a Method Thereof

(71) Applicants: Robert Bosch GmbH, Stuttgart (DE); Bosch Global Software Technologies Private Limited, Koramangala (IN)

(72) Inventors: Koustav Mullick, Kolkata (IN); Amit Arvind Kale, Karnataka (IN); Katja Laurischkat, Renningen (DE)

(21) Appl. No.: 19/551,123

(22) Filed: Feb. 26, 2026

(30) Foreign Application Priority Data
Feb. 27, 2025 (IN) 2025 4101 7194

(51) Int. Cl. G06N 20/00

(52) U.S. Cl. CPC G06N 20/00

(57) ABSTRACT

A control unit receives at least two types of data from corresponding multiple sources and performs a first random data sampling on the received at least two types of data for training the intelligence module. The control unit computes a score for every datapoint of the received at least two types of data and performs a second data sampling on the received at least two types of data based on the computed score of every datapoint. The control unit fine-tunes the intelligence module with the at least two data types obtained after the second data sampling completion and validates the fine-tuned intelligence module with a validation dataset.

This application claims priority under 35 U.S.C. § 119 to patent application no. IN 2025 4101 7194, filed on Feb. 27, 2025 in India, the disclosure of which is incorporated herein by reference in its entirety.

The disclosure is related to a control unit for fine-tune an intelligence module using multiple data types and a method thereof.

### BACKGROUND

Most of the literature relates to usage of synthetic data for boosting network performance that focuses on generating large volumes of diverse and high-quality vision data, tailored to specific scenarios and edge cases that are hard to capture in real-world data. However, post generation there are no further filtering module to identify the synthetic data points which are actually usable in imparting complementary knowledge to train the network and are simply combined with the existing real-world data and used for training as a whole.

A US 20200320347 patent application discloses a system and method are disclosed for training a system or a model using any combination of synthetic data and real data. The various aspects of the disclosure include generation of data that is used to supplement or augment real data, wherein the subject of the data can be segmented. Labels or attributes are automatically added to generated data. The generated data is synthetic data that is created using the seed or real data as well as from other synthetic data. Using the synthetic data, various domain adaptation models can be used and trained for unsupervised domain adaptation.

### BRIEF DESCRIPTION OF THE DRAWINGS

FIG. 1 illustrates a control unit for fine-tuning an intelligence module using multiple data types in accordance with an embodiment of the disclosure; and

FIG. 2 illustrates a flowchart disclosing a method of fine-tuning an intelligence module using multiple data types by a control unit in accordance with the present disclosure.

### DETAILED DESCRIPTION

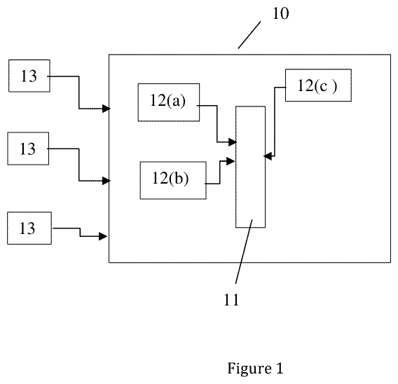

FIG. 1 illustrates a control unit for fine-tuning an intelligence module using multiple data types in accordance with an embodiment of the disclosure. The control unit 10 receives at least two types of data (12a,12b) from corresponding multiple sources 13 and performs a first random data sampling on the received at least two types of data (12a,12b) for training the intelligence module 11. The control unit 10 computes a score for every datapoint of the received at least two types of data (12a,12b) and performs a second data sampling on the received at least two types of data (12a,12b) based on the computed score of every datapoint. The control unit 10 finetunes the intelligence module 11 with the at least two data types (12a,12b) obtained after the second data sampling completion and validates the fine-tuned intelligence module 11 with a validation dataset (12c).

Further the construction of the control unit 10 and the working component of the control unit 10 is explained in detail. The control unit 10 and the operation of the different components connected to the control unit 10 is explained in detail. The methodology is deployed in the control unit 10 and the working of the control unit 10 is not a mere software program perse, but a means and function kind of arrangement where multiple hardware modules (the intelligence module, multiple data sources connected to) are involved, each performing a particular task. The control unit 10 is an operating device that is used to process and to store the information received from at least one source. The control unit 10 is chosen from a group of control units comprising microprocessors, microcomputers, microcontrollers, digital signal processors, central processing units, state machines, logic circuitries, one or more microchips or integrated circuits interconnected using a parent board, hardwired logic, software stored by a memory device and executed by a microprocessor, firmware, an application specific integrated circuit (ASIC), and/or a field programmable gate array(FPGA), and/or any component that operates on signals based on operational instructions. It is to be noted that, the control unit 10 can be of any other kind, but not limited to the above-mentioned devices which are known to a person skilled in the art.

The first and the second data sampling is a smart incremental training technique where the data is partitioned between at least two types of data (12a,12b), while selecting per epoch training data. The at least two types of data (12a,12b) comprises a real dataset (12a) and a synthetic dataset (12b) and wherein one epoch comprises multiple iterations and each iteration is performed on each subset of datapoints of the real dataset (12a) and the synthetic dataset (12b). For example, the real data set (12a) comprises “a” number of data points, then a number “b” of datapoints are made into a batch. In the real data set (12a), there will be plurality of batches each having “b” number of datapoints.

And the number of iterations that can be conducted with all the datapoints of the real dataset (12a) is computed from number of datapoints and number of datapoints being in each batch. Here it is “a/b”. This number is equivalent to one epoch. All the datapoints are used to train the intelligence module 11 when a random data sampling technique is done. Smart incremental training is the method of data partitioning between the real data (12a) and synthetic data (12b) while selecting per epoch training data. This provides to overcome the problems of both overfitting on new data and catastrophic forgetting of the trained/seen data, while reducing the training time. It also enables to keep a track of selecting the most influential synthetic data points (12b) which helps in the best gains in performance.

For each of the data point the score and the score is a weighted linear combination of a difficulty in terms of entropy and a measure of repetition (which is weighted negatively). This score signifies the “importance” of each data point during that iteration of training of the intelligence module 11, which is based on the module's 11 weight at that snapshot. As the module 11 gets better and weights are updated, these scores will also vary across iterations.

The first random data sampling and the second data sampling are a user defined numerical value, in such a way that, a portion of that numerical value data is selected from the above mentioned two types of data (12a,12b). For example, the random data sampling for the real data (12a) and the synthetic data (12b) can be 30% of the overall datapoints present in the real data (12a) and 30% of the overall datapoints present in the synthetic data (12b). The second data sampling value is considered in such a way that, the selected data will have the highest computed score. Ie., once the score is computed for the each of the datapoints in both of the real data set (12a) and the synthetic dataset (12b), then the control unit 10 takes into consideration the percentage/numerical value (provided by the user) for training/finetuning the intelligence module 11.

Such an approach provides improvements over the limitations of blindly augmenting synthetic data (12b) to the training set of classifiers, as presented in the previous section. Random data sampling (first and second) based selection, allows randomness to ensure regularized and robust training of the intelligence module 11. The score computation makes the selection logical, while also ensuring that the intelligence module 11 does not overfit on “noisy” samples, as well as good coverage of the training population is maintained. Flexibility of user defined hyperparameters, and score computation allows the intelligence module 11 to be adopted to any scenario, based on user preference. The random data sampling technique provides multiple iterations of data such that, each datapoint is used to train the intelligence module 11 at a given point of time.

Once the intelligence module 11 is fine-tuned, it is validated using the validation dataset. The validation dataset is an unseen real-world data which is provided as an input to the intelligence module 11 in a real-time kind of environment. With this validation, the user can understand the accuracy and efficiency of the trained intelligence module.

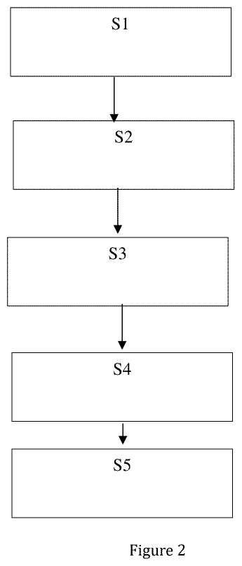

FIG. 2 illustrates a flowchart disclosing a method of fine-tuning an intelligence module 11 using multiple data types (12a,12b) by a control unit 10 in accordance with the present disclosure. The method comprises the following steps. In step S1, at least two types of data (12a,12b) from corresponding multiple sources 13 are received. In step S2, a first random data sampling is performed on the received at least two types of data (12a,12b) for training the intelligence module 11. In step S3, a score for every datapoint of the received at least two types of data (12a,12b) is computed. In step S4, a second data sampling on the received at least two types of data (12a,12b) is performed based on the computed score of every datapoint. In step S5, the intelligence module 11 is finetuned with the at least two data types obtained after the second data sampling completion and the fine-tuned intelligence module 11 is validated with a validation dataset (12c).

The method is explained in detail. The intelligence module 11 used in any of the applications like autonomous driving, health care, retail, production is built and trained using large number of datasets. However, in the real time kind of environment, there are chances of the intelligence module 11 to provide an incorrect output related to the an input provided. The present disclosure solves the problem by training the data multiple times with at least two different types of datasets (12a,12b). The multiple dataset types (12a,12b) comprises the real images and synthetic images. Subsequently the control unit 10 is also provided with selective (generative artificial intelligence (gen AI)) data that is most relevant for improving a classifier performance in the intelligence module 11.

To achieve these two, the control unit 10 follows the mentioned two types of techniques. One being to append the real and synthetic data sets (12a,12b) together to train the network and other to fine-tune the intelligence module 11 that is originally trained using the real data (12a), with the synthetic data (12b). However, there are challenges with respect to each of these approaches/techniques. One is, a highly inefficient intelligence module 11, as it involves large training time and cost. It is possible that, when the of redundancy in the synthetic data (12b) is not taken care, then the intelligence module 11 performance may be lower. And second is risk of overfitting on the synthetic data (12b) and reduce the performance on the validation dataset. Additionally, there is also a risk of the synthetic data (12b) being repetitive and not really imparting any additional information which leads to consequent improvement in real validation dataset (12c).

In order to the overcome the above-mentioned problems, the present disclosure provides a solution by proposing a smarter way of data partitioning between real and synthetic training data (12a,12b) while selecting per epoch training data using the below steps. The real dataset (12a) is considered as T1, and the synthetic dataset (12b) is considered as T2. In the first step, the control unit 10 receives the synthetic data (12b), perform a model agnostic smart data selection. In the second step, the control unit 10 uses an user specified fraction of the data that is considered for training (y—Percentage of data to be considered for training in each iteration), which is conditional on the resource and computation available to train the intelligence module 11.

In the third step, subsequently the control unit 10 also provides another user specified ratio of real data (x1) and synthetic data (x2) , which determines the amount of data from both dataset (12a,12b) that will be considered per epoch while updating the intelligence module 11. Ideally this ratio can also be determined based on the accuracy of the classifier on the held-out validation set. Based on performance on the real validation set, accordingly the ratio of x1 and x2 also needs to be set accordingly.

Gradually as training progresses, the performance on the validation set 12c will show improvement until it approaches convergence. As and when it improves, the ratio x1 and x2 can also be automatically adjusted to reweigh the ratio of real and synthetic training data considered during training. In the fourth step, the score which is novel in nature is computed for every datapoint, the score is a weighted linear combination of difficulty in terms of entropy, a measure of repetition (weighted negatively) and other functions.

Based on a requirement, additional scoring functions can also be included in the final score to signify the importance of the training data points. This score signifies the “importance” of each data point during that iteration of training, which is based on the intelligence module's 11 weight at that snapshot. As the intelligence module 11 gets better and weights are updated, these scores will also vary across iterations.

In the next step, given the fraction of the data for training the top x1 and x2 parts of the data T1 and T2 (ordered in descending order) and used for training a neural network of the intelligence module. This allows the intelligence module 11 to focus on the datapoints that it considered “new”, or “novel” at that stage of training and learn better. It also encourages learning complementary information from the synthetic data (12b), without forgetting what it has already learnt from the real data (12a) and use both the available sources of information to reach the best possible accuracy.

In the next step, since the control unit 10 have two training data types (12a,12b) which are the real data (12a) and the synthetic data (12b), but validation performance is only obtained when the intelligence module 11 is validated with a real validation dataset (12c). The intelligence module 11 is saved only if real validation accuracy improves.

The above method is explained with an example. The intelligence module 11 is trained with two types of datasets(12a,12b), one being the real dataset (12a) and other being the synthetic data set (12b). From the two types of dataset(12a,12b), a random percentage of datapoints are taken to train the intelligence module 11. For example, the real data set (12a) comprises 100 datapoints and the synthetic dataset (12b) comprises 100 datapoints. Then, a batch of 5 datapoints are considered, which makes it as 20 iterations are to be performed to complete training with all the data points. These 20 iterations of 5 batch of datapoints are called as one epoch. The control unit 10 trains the intelligence module 12 with multiple epoch's, in such a way that, the random data sampling value is varied for each of the epoch. Ie., a 30% of the 100 images are considered first to train the intelligence module 11. 30% of each data set (real data set (12a) and the synthetic dataset (12b)) is considered to train the intelligence module 11. This random data sampling value is a user defined value. Due to the iteration mechanism, all the datapoints of both types of datasets (12a,12b) are used to train the intelligence module 11.

Once this process is over, the control unit 10 computes the score for every data point of both types of datasets (12 a,12b). Ie., each of the image of the 30 images of the real dataset (12a) and the 30 images of the synthetic dataset (12b) will have a respective score. The score is computed on the randomly sampled 100 images from the previous step. And the computation of the score is done using the below formula:

$$Score = α * difficulty + β * ( - repetition ) + …$$

$$α , β = weighing parameters d$$

$$ifficulty = Entropy score of that sample ,$$

$$repetition = Number of times the \\ example is already seen by the network while trainings$$

$$… = Based on requirement other weighing parameters .$$

The high score data points are considered first to re-train the intelligence module 11, whereas the data points that have less score is ignored. Now based on the score, the control unit 10 performs the data sampling technique again. In this step, based on the user-defined data sampling value, the data points are selected. Based on user-defined sampling value, the data points having the “highest scores” computed in previous step, are selected. So basically 30 real and 30 synthetic data points above are descending sorted based on score, and the top user-defined percentage of data points having the highest scores are sampled in this step. It is to be noted that, the first random data sampling value is different from the second data sampling value. According to one embodiment of the disclosure, the first random data sampling value and the second data sampling value is similar. Based on the second sample value, the selected data points are used to train/fine-tune the intelligence module 11. Once this process is completed, the intelligence module 11 efficiency is checked with the help of the validation data set 12c. The validation data set 12c is the real time data set that is used to provide as an input to the intelligence module 11 to obtain the correct output.

It should be understood that embodiments explained in the description above are only illustrative and do not limit the scope of this disclosure. Many such embodiments and other modifications and changes in the embodiment explained in the description are envisaged. The scope of the disclosure is only limited by the scope of the claims.

What is claimed is:

1. A control unit for fine-tune an intelligence module using multiple data types, said control unit configured to:
receive at least two types of data from corresponding multiple sources;
perform a first random data sampling on the received at least two types of data for training the intelligence module;
compute a score for every datapoint of the received at least two types of data;
perform a second data sampling on the received at least two types of data based on the computed score of every datapoint;
fine-tune the intelligence module with the at least two data types obtained after the second data sampling completion; and
validate the fine-tuned intelligence module with a validation dataset.

2. The control unit as claimed in claim 1, wherein the first random data sampling and the second data sampling is a smart incremental training technique wherein the data is partitioned between at least two types of data, while selecting per epoch training data.

3. The control unit as claimed in claim 2, wherein the at least two types of data comprises a real dataset and a synthetic dataset and wherein one epoch comprises multiple iterations and each iteration is performed on each subset of datapoints of the real dataset and the synthetic dataset.

4. The control unit as claimed in claim 1, wherein the score computed for every datapoint is a weighted linear combination of a difficulty in terms of entropy and a measure of repetition, which is weighted negatively.

5. The control unit as claimed in claim 1, wherein the first random data sampling and the second data sampling is a user defined numerical value, in such a way that, a portion of that numerical value data is selected from the above mentioned two types of data.

6. The control unit as claimed in claim 5, wherein the second data sampling value is considered in such a way that, the selected data will have the highest computed score.

7. The control unit as claimed in claim 1, wherein the random data sampling technique provides multiple iterations of data such that, each datapoint is used to train the intelligence module at a given point of time.

8. The control unit as claimed in claim 1, wherein the validation dataset is an unseen real-world data which is provided as an input to the intelligence module in a real-time kind of environment.

9. A method of fine-tuning an intelligence module using multiple data types by a control unit, the method comprising:
receiving at least two types of data from corresponding multiple sources;
performing a first random data sampling on the received at least two types of data for training the intelligence module;
computing a score for every datapoint of the received at least two types of data;
performing a second data sampling on the received at least two types of data based on the computed score of every datapoint; and
fine-tuning the intelligence module with the at least two data types obtained after the second data sampling completion and validating the fine-tuned intelligence module with a validation dataset.
